(19) United States
(12) Patent Application Publication
(10) Pub. No.: US 2011/0272341 A1
(43) Pub. Date: Nov. 10, 2011

(54) Hollow Fiber Ultrafiltration Membrane Filter

(75) Inventors: Pansheng Qian, Jiangsu (CN); Lizhong Liu, Jiangsu (CN)

(73) Assignee: Jiangsu Jinshan Environmental Protection Engineering Co., Ltd., Yixing, Jiangsu (CN)

(21) Appl. No.: 13/142,596

(22) PCT Filed: Apr. 21, 2010
(86) PCT No.: PCT/CN2010/072004

§ 371 Date: Jun. 29, 2011

(30) Foreign Application Priority Data
Sep. 21, 2009 (CN) 200910183430.0

(51) Int. Cl. B01D 63/02; C02F 1/44

(52) U.S. Cl. 210/456

(57) ABSTRACT

A hollow fiber ultrafiltration membrane filter is provided. The hollow fiber ultrafiltration membrane filter includes a main membrane body, wherein outer cylinders are sleeved at an upper end and a lower end of the main membrane body, and a hollow fiber is arranged in the main membrane body. The hollow fiber ultrafiltration membrane filter has the advantages of beautiful appearance, convenient fabrication and assembly, high flux, good sealing performance, and small space occupation, thus being particularly applicable to industrial water purification.

### FIELD OF THE INVENTION

The present invention relates to an ultrafilter in the water treatment field, and more particularly to a hollow fiber ultrafiltration membrane filter.

### BACKGROUND OF THE INVENTION

Presently, in ultrafiltration membrane components used in the water treatment field, plexiglass tubes are generally adopted as membrane shells. However, the plexiglass tubes are easily broken, and the distribution of resin is uneven during pouring, the installation is difficult, and the flux is low. In some ultrafiltration membrane components, UPVC tubes are adopted as membrane shells, and ABS engineering plastic is used to make outer cylinders, when being bonded, the two different materials cannot be bonded firmly, thus resulting in water leakage. Furthermore, as the UPVC tubes have poor tensile strength and flexibility, and always have brittle features, low elongation rate, thus being easily broken. When connecting a sealing structure to external components, threaded connection is generally adopted, or a washer is directly pressed on, so that the sealing performance is poor and water leakage is likely to occur. The flow direction of a water distributor adopts large perforation cross flow, which increases the impact on membrane thread, thus resulting in early fatigue and break of the membrane thread with the increase of water inflow.

### SUMMARY OF THE INVENTION

In view of the disadvantages in the prior art, the present invention is directed to a hollow fiber ultrafiltration membrane filter with good sealing performance, convenient assembly, high flux, and unbreakable membrane thread.

The present invention adopts the following technical solution.

A hollow fiber ultrafiltration membrane filter is provided, which includes a main membrane body, outer cylinders are sleeved at an upper end and a lower end of the main membrane body, a hollow fiber is disposed in the main membrane body, a water distributor is disposed at an upper end of the hollow fiber, a membrane sub-grid support is disposed at a lower end of the hollow fiber, diameters of water distribution holes of the water distributor are gradually increased with the increase of the distance to a water inlet, the water distribution holes are disposed annularly, an upper portion of the outer cylinder at the upper end of the main membrane body is connected to a top head, a lower portion of the outer cylinder at the lower end of the main membrane body is connected to a bottom head, and a port is disposed at the lower end of the bottom head.

The material of the outer cylinders and the material of the main membrane body are ABS engineering plastic.

The membrane sub-grid support has six evenly distributed sub-grids.

The outer cylinders at the upper and lower ends of the main membrane body are connected to the top head and the bottom. head through a sealing ring for sealing respectively.

A fastening device is disposed at a junction of the outer cylinders at the upper and lower ends of the main membrane body and the top head and the bottom head. The fastening device is assembled by four 90-degree arc modules spot soldered on a steel ring.

The present invention has the following beneficial effects.

The appearance is beautiful, the fabrication and assembly are convenient, the flux is high, and the sealing performance is good. The outer cylinders and the main membrane body have high impact strength, high chemical stability, and high flexibility. The special perforation structure of the water distributor ensures even water distribution in back flush or water inflow; moreover, as the flow direction of the water is parallel to the direction of the membrane thread, the impact on the membrane thread is decreased, and the membrane thread will not fatigue or break, thus prolonging the service life of the membrane.

### BRIEF DESCRIPTIONS OF THE DRAWINGS

The present invention will become more fully understood from the detailed description given herein below for illustration only, and thus are not limitative of the present invention, and wherein:

FIG. 1 is a schematic structural view of the present invention;

FIG. 2 is a schematic structural view of a water distributor according to the present invention; and

FIG. 3 is a schematic structural view of a fast-assembled fastening device according to the present invention.

### DETAILED DESCRIPTIONS OF THE INVENTION

The present invention is further illustrated below with reference to the accompanying drawings.

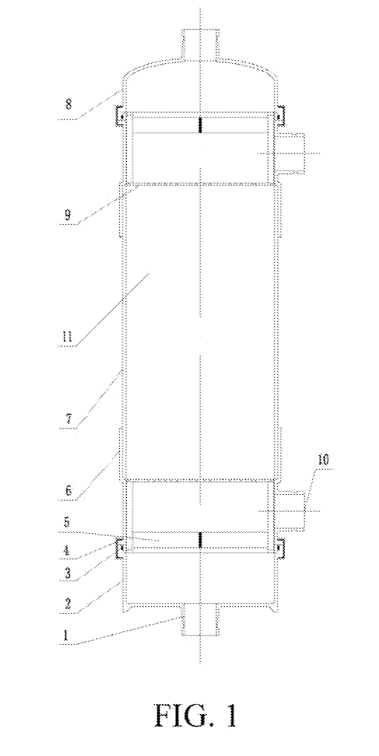

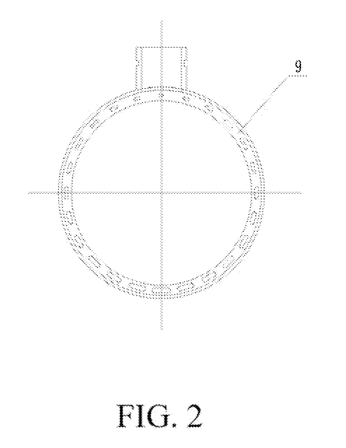

As shown in FIG. 1, outer cylinders 6 are sleeved at an upper end and a lower end of a main membrane body 7 of the present invention. A hollow fiber 11 is disposed in the main membrane body 7, a water distributor 9 is disposed at an upper end of the hollow fiber 11, and a membrane sub-grid support 5 is disposed at a lower end of the hollow fiber 11. As shown in FIG. 2, diameters of water distribution holes of the water distributor 9 of the present invention are gradually increased with the increase of the distance to a water inlet 10, and the water distribution holes are disposed annularly. The water distributor 9 distributes water by using tank-type bottom. perforation. The diameter and the number of the water distribution holes get small at the part close to the water inlet, and the diameter and the number of the water distribution holes get large at the part far away from the water inlet according to the principle that the cross sections of the water distribution holes are in proportion to the water inflow paths. The water distribution holes are opened around the water inlet, so as to ensure even water distribution in back flush or water inflow. The flow direction of the water is parallel to the direction of the membrane thread, so that the impact on the membrane thread is decreased, and the membrane thread will not fatigue or break, thus effectively prolonging the service life of the membrane. An upper portion of the outer cylinder 6 at the upper end of the main membrane body 7 is connected to a top head 8, a lower portion of the outer cylinder 6 at the lower end of the main membrane body 7 is connected to a bottom head 2, and a port 1 is disposed at a lower end of the bottom head 2.

The material of the outer cylinders 6 and the material of the main membrane body 7 in the present invention are ABS engineering plastic, and are bonded with a uniform ABS special adhesive, and firm bonding can be achieved for the same material. Moreover, the ABS engineering plastic has high comprehensive performance, high impact strength, high chemical stability, and high flexibility.

The membrane sub-grid support 5 of the present invention has six evenly distributed sub-grids, and thus resin pouring and assembly are more convenient.

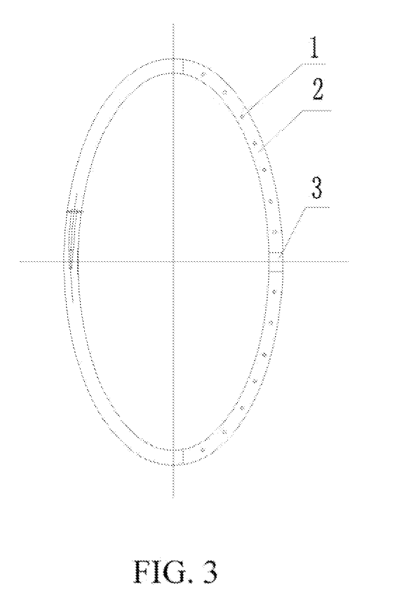

The outer cylinders 6 at the upper and lower ends of the main membrane body 7 of the present invention are connected to the top head 8 and the bottom head 2 through a sealing ring 3 for sealing respectively. Furthermore, a notch is disposed at the assembly site of the sealing ring 3 for fixing, so as to prevent the sealing ring from getting loose, and obtain high sealing performance. Moreover, a junction of the outer cylinders 6 at the upper and lower ends of the main membrane body 7 and the top head 8 and the bottom head 2 is fixed through a fastening device 4. As shown in FIG. 3, the fastening device 4 is assembled by four 90-degree arc modules 10 spot soldered on a steel ring 9. The solder joints 11 are evenly distributed at the 90-degree arc module 10, and thus the required processing mold is small, the fabrication is convenient, the cost is low, the installation is easy, the sealing performance is good, and water leakage does not occur.

The rest part of the present invention that is not illustrated herein is the same as that in the prior art.

1. A hollow fiber ultrafiltration membrane filter, comprising a main membrane body, wherein outer cylinders are put on an upper end and a lower end of the main membrane body, hollow fibers is arranged in the main membrane body, a water distributor is arranged at an upper end of the hollow fibers, a membrane sub-grid support is arranged at a lower end of the hollow fiber, diameters of water distribution holes of the water distributor are gradually increased with a distance to a water inlet, the water distribution holes are arranged annularly, an upper portion of the outer cylinder on the upper end of the main membrane body is connected to a top head, a lower portion of the outer cylinder on the lower end of the main membrane body is connected to a bottom head, and a port is arranged at the lower end of the bottom head.

2. The hollow fiber ultrafiltration membrane filter according to claim 1, wherein material of the outer cylinders and the main membrane body is ABS engineering plastic.

3. The hollow fiber ultrafiltration membrane filter according to claim 1, wherein the membrane sub-grid support has six evenly distributed sub-grids.

4. The hollow fiber ultrafiltration membrane filter according to claim 1, wherein the outer cylinders at the upper and lower ends of the main membrane body are connected to the top head and the bottom head through a sealing ring for sealing respectively.

5. The hollow fiber ultrafiltration membrane filter according to claim 1, wherein a fastening device is arranged at a junction of the outer cylinders at the upper and lower ends of the main membrane body and the top head and the bottom head respectively, and the fastening device is assembled by four 90-degree arc modules spot soldered on a steel ring.

6. The hollow fiber ultrafiltration membrane filter according to claim 4, wherein a fastening device is arranged at a junction of the outer cylinders at the upper and lower ends of the main membrane body and the top head and the bottom head respectively, and the fastening device is assembled by four 90-degree arc modules spot soldered on a steel ring.
